(19) United States
(12) Patent Application Publication
(10) Pub. No.: US 2019/0126097 A1
(43) Pub. Date: May 2, 2019

(54) Resistance Band Measuring Device

(71) Applicant: CIRCUBAND LIMITED, Christchurch (NZ)

(72) Inventor: Daniel Craig THOMSON, Hamilton (NZ)

(73) Assignee: Circuband Limited, Christchurch (NZ)

(21) Appl. No.: 16/092,611

(22) PCT Filed: Apr. 12, 2017
(86) PCT No.: PCT/NZ2017/050042

§ 371 Date: Oct. 10, 2018

(30) Foreign Application Priority Data
Apr. 12, 2016 (NZ) 718979

(51) Int. Cl. A63B 24/00; A63B 21/00; A63B 21/055; A63B 71/06; A63F 13/218

(52) U.S. Cl. CPC A63B 24/0062; A63B 21/4035; A63B 21/0555; A63B 71/0622; A63B 21/00185; A63B 21/0557; A63F 13/803; A63B 2071/0627; A63B 2071/0655; A63B 2220/51; A63B 2220/833; A63B 2225/52; A63B 2024/0096; A63F 13/218

(57) ABSTRACT

A load sensing device for use with an exercise band is disclosed. The load sensing device comprises a band of resilient material, a load sensor attached to the band and configured to measure an extension force applied to the band, and an electronic circuit configured to measure the applied extension force and to wirelessly transmit a signal representative of the applied extension force to a receiver. The band of resilient material protects the load sensor and the electronic circuit from damage by at least partially surrounding them.

### TECHNICAL FIELD

The present invention relates to a novel and inventive apparatus and method of use in relation to the measurement of an extension force, or strain, applied to a resistance band.

### BACKGROUND ART

Resistance bands have become a popular tool for many fitness enthusiasts. The reason for this, is that resistance bands, offer excellent dynamic range and flexibility, in terms of motions and resistances, that can be exploited during exercise; without the expense and space requirements of weights, or traditional gym equipment.

One downside of resistance band training, is the difficulty in controlling and maintaining the consistency of the muscle loading, applied over the course of a training program. Inconsistency, may exist between bands, and band elasticity, may vary over time, and with environmental conditions; such as temperature. This makes it difficult to provide highly structured training programs, such as is required for physical therapy. An inability to measure the extension force, applied by a band, also makes it difficult to measure developmental improvement over, the course of a training program.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be are referred to herein, this reference does not constitute an admission that any of these documents form part of the common general knowledge in the art, in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

It is an object of the present invention to address any one or more of the foregoing problems or at least to provide the public with a useful choice.

### DISCLOSURE OF THE INVENTION

The present invention relates to a method and apparatus, for measuring the extension force, applied to an exercise band, and for reporting the measured extension force to a user. In one embodiment, the invention includes a load sensing device, that measures applied extension force, applied to an exercise band, over the duration of an exercise program. The invention thereby allowing a user, coach or physical therapist, to monitor developmental progress, over a period of training with the exercise band. More advanced embodiments, provide feedback to the user, to indicate a level of extension force achieved, a number of repetitions, or any other goal based notification. Yet further embodiments, provide the user with the ability to interact with computer software, such as controlling an avatar in a game, thereby making an exercise regime more entertaining.

According to a first aspect of the present invention there is provided a load sensing device for use with an exercise band, the load sensing device including:
a band of resilient material;
a load sensor attached to the band and configured to measure an extension force applied to the band; and
an electronic circuit configured to measure the applied extension force and to wirelessly transmit a signal representative of the applied extension force to a receiver;

wherein the band of resilient material protects the load sensor and the electronic circuit, from damage, by at least partially surrounding them.

In preferred embodiments, the load sensing device may include a further band of resilient material, wherein the load sensor is positioned so as to be sandwiched between the band of resilient material and the further band of resilient material.

Positioning the load sensor between the bands of resilient material serves to protect the load sensor from damage, in particular from crushing and excessive tensile forces.

In preferred embodiments, the or each, band of resilient material may include one or more of:
rubber;
elastic, or
elastomer.

It will be understood that measuring of a force by the load sensor and/or electronic circuit does not necessarily require that the load sensor and/or electronic circuit measure(s) force directly or that the load sensor and/or electronic circuit measure(s) a magnitude of force in a particular unit such as kilograms or Newtons.

In some embodiments, a load sensor may be configured to measure an extension force applied to a band by measuring an extension of the band.

Similarly, in some embodiments the extension of the band is not measured directly or in units of length, but may be measured by measuring a property of the band or an associated component which indicates the length and/or force applied to the band.

In some embodiments, the load sensor may be a component attached to the band such that a load applied to the band causes a change in a property of the load sensor which can be measured and from which the force on the band is able to be determined.

In some embodiments, the load sensor may have a capacitance and be attached to the band such that an extension force applied to the band produces a change in the capacitance of the load sensor. The change in capacitance or other relevant characteristic of the load sensing device may be produced by deformation of the band, such as extension of the band caused by the applied force.

The electronic circuit of the load sensing device may be configured to measure the applied extension force by detecting or measuring change in a property of the load sensor.

In some embodiments, the property is an electrical characteristic of the load sensor. In some embodiments, the electronic circuit may be configured to measure the applied extension force by measuring or detecting the capacitance of the load sensor.

In some embodiments, the signal representative of the applied extension force that the electronic circuit transmits to a receiver may be a signal representative of a property of the load sensor that is indicative of the extension force applied to the band.

In some embodiments, the electronic circuit is configured to measure or detect the capacitance of the load sensor to measure the applied extension force, and to wirelessly transmit a signal representative of the capacitance to a receiver.

In some embodiments, the receiver may be a device, or part of a device, which is configured to determine the applied extension force based on the received signal. The receiver may interpret the signal as a measure of a property or characteristic of the load sensor (e.g. capacitance, resistance and the like) and determine an applied extension force corresponding to that property or characteristic. The receiver may determine an applied extension force based on known behavior or properties of the band, such as a force-displacement (or force-capacitance) characteristic. The receiver may execute one or more algorithms to determine the applied extension force based on a signal representative of the applied extension force received from the electronic circuit and/or load sensor.

In some embodiments the load sensor and the electronic circuit may be integrated in the same component (e.g. they may be a single device).

In some embodiments, the load sensor and electronic circuit may be separate devices or components operatively connected to each other.

Preferably, the load sensor may be configured to measure a distortion in the band of resilient material.

Because the physical constituency of the band of resilient material, remains essentially constant during stretching, the dimensions of the band, must vary as the band is stretched and released. Typically, this results in a combination of thinning, in both width and depth, as well as, elongation of the band. One or more of these variations, can be measured, directly or indirectly, to accurately determine the force that is being applied to cause the distortion.

In preferred embodiments, the distortion that is measured, may be one or more of a thinning, or elongation, of the band of resilient material.

Preferably, an electrical characteristic of the load sensor varies as the band of resilient material is distorted.

There are a number of load sensors, and distortions of the band of resilient material, that may be employed, to measure the extension force, that is being applied to the band of resilient material. Examples include, but should not be limited to:
resistive strain gauges, in which the width of resistive traces widen and narrow with elongation, thereby varying the resistance thereof;
capacitive sensors, in which the distance between electrical plates varies as the band elongates or thins; or
Electro-active polymer materials such as that sold under the brand Stretchsense™.

Preferred embodiments, may include a first removable fastener, at a first end thereof, wherein the removable fastener, is configured to removably attach, to a complementary fastener attached to an exercise band.

Preferably, a second removable fastener may be provided at an opposite end to the first end, wherein the second removable fastener, is configured to removably attach to a complementary fastener, attached to an exercise band accessory.

In some embodiments the fasteners are male and female buckles. In other embodiments the fasteners are carabiners or other suitable connectors.

Preferably, the exercise band accessory is a human interface device, or an attachment for connecting the exercise band to a fixed object.

In use an exercise band, may have any number of human interface devices attached to it, such as handles, loop fasteners for wrists or ankles, attachments to balls, paddles, bars, bats or any other piece of sporting equipment.

In addition, an exercise band may be used alone, or fastened to an object, such as a wall, door, window frame, post, tree or the like. When attached to a fixed object an attachment for connecting the exercise band to a fixed object is used such as a strap, belt, buckle, hook or the like.

Both the human interface device and the attachment for connecting the exercise band to a fixed object should not be seen as being limited in their form or function.

Preferably, the receiver may include a microprocessor, configured to receive and decode, the transmitted signal representative of the applied extension force.

In the context of the present application, a microprocessor should be understood to refer to a central processing unit, and its associated peripheral hardware, such as memory, power, I/O interfaces and the like, and any software code running thereon for the purposes of performing any intended processing and signaling functions.

In preferred embodiments, the microprocessor may provide a feedback signal to a user of the load sensing device, the feedback signal indicative of the level of strain applied to the load sensing apparatus.

In some preferred embodiments the microprocessor may provide feedback signal, to a user of the load sensing device, when a pre-determined level of extension force, has been applied to the load sensing apparatus.

In preferred embodiments the pre-determined level of extension force is configurable.

A configurable indication of extension force, is useful for physical therapy applications, where a relatively low extension force is required to ensure an injury receives a therapeutic level of exercise and is not damaged by being over-strained.

It will be appreciated that the pre-determined level of extension force will be configured, on an individual basis, by a trainer or physical therapist, to suit a particular user's exercise or rehabilitation needs.

Preferably the feedback signal is one or more of:
an audible alert
a visual indication
a tactile signal.

Providing a feedback signal indicative of a pre-determined level of extension force being applied is advantageous, in that a user, is more easily able to avoid the risk of overstraining damaged tissue, or performing an exercise at a sub optimal level, than they would from relying on perceived strain.

In some preferred embodiments, the feedback signal may be provided by way of an action in a game For example, when a desired level of extension force is applied, an action such as a jump, turn or the like, may be effected within the game. In this manner the user may be able to partake in a game or simulation during exercise.

In some embodiments, the processor may record a user's exercise routine to a non-volatile memory.

Recording a user's exercise routine, allows a personal trainer or physical therapist, to monitor and determine developmental improvements, in a user's performance over time. This provides a tool for gauging adjustment to be made, to pre-determined feedback signals, for a specific user, to ensure the user is exercising, at an optimal level, for their needs and development.

According to a second aspect of the present invention there is provided a method for measuring the extension force applied to an exercise band, the method including the steps of:

a) measuring an extension force applied to the exercise band by way of a load sensing device;

b) transmitting a signal representative of the measured extension force wirelessly from the load sensing device to a receiver;

c) processing the signal representative of the measured extension force at the receiver, and d) providing a feedback signal to the user indicative of their performance.

In preferred embodiments, processing of the signal representative of the measured extension force may be performed by a microprocessor associated with the receiver.

In preferred embodiments, the feedback signal to the user may be provided in a number of ways, including, but not being limited to:
a report displayed at the completion of the exercise regime;
a display on a screen representative of the extension force being applied;
a visual indication of an extension force level;
the movement of an avatar on a screen;
an audible indication of an extension force level achieved, or
a tactile indication of an extension force level achieved.

In some preferred embodiments the method includes the further step of:
e) a user setting a pre-defined threshold of extension force at which a feedback signal is to be provided to a user.

Embodiments of the present invention may provide a number of advantages over the prior art, examples of which may include, but should not be limited to:
providing a useful tool that allows a user of an exercise band to more accurately monitor their exercise band use;
providing a useful tool that allows a personal trainer or physical therapist to monitor and control a routine performed by a user of an exercise band;
providing a tool that allows an exercise band to act as a controller for a computer system, and
providing a tool that transforms a basic exercise tool into a sophisticated tool for rehabilitation and physical enhancement.

Further aspects and advantages of the present invention will become apparent from the ensuing description which is given by way of example only.

### DETAILED DESCRIPTION OF DRAWINGS

Preferred embodiments of the present invention will now be described by way of example only and with reference to the accompanying drawings in which:

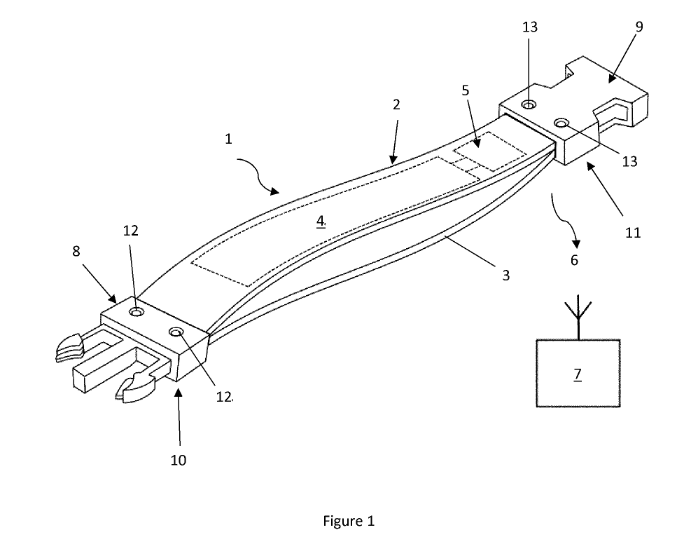

FIG. 1 shows a perspective view of a load sensing device in accordance with a preferred embodiment of the present invention;

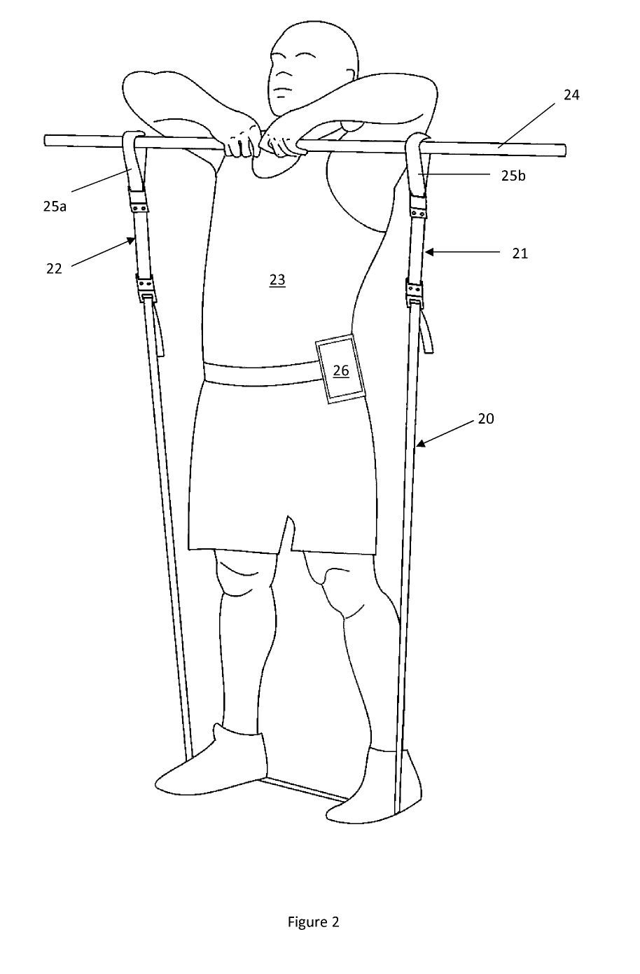

FIG. 2 shows a perspective view of the load sensing device of FIG. 1 whilst in use;

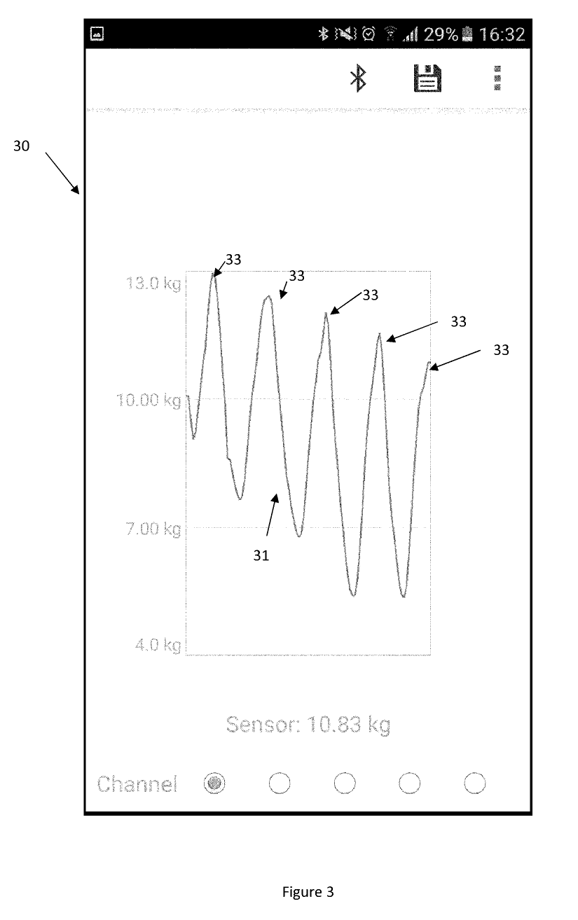

FIG. 3 shows a visual indication as provided in a preferred embodiment of the present invention;

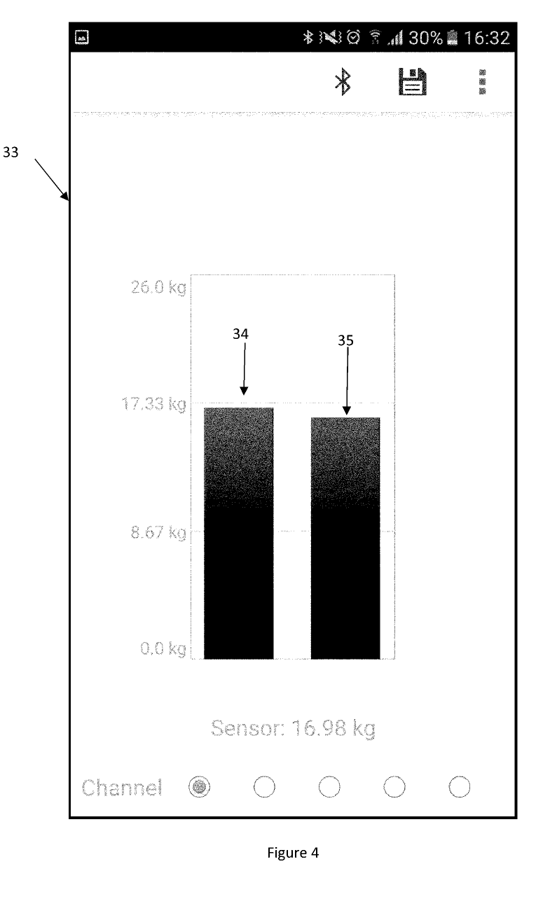

FIG. 4 shows a further visual indication as provided in a preferred embodiment of the present invention.

### BEST MODES FOR CARRYING OUT THE INVENTION

Referring to FIG. 1 there is shown a load sensing device for use with an exercise band, as generally indicated by designator 1.

The load sensing device 1 includes a band of resilient material in the form of a first elastic band 2 and a parallel second elastic band 3. A load sensor 4, not visible but shown as hidden detail, in the form of a Stretchsense™ sensor is attached between the first elastic band 2 and the second elastic band 3. The load sensor is configured to measure the extension force applied along the length of the parallel first elastic band 2 and second elastic band 3. An electronic circuit 5, not visible but shown as hidden detail, is provided which is configured to monitor the load sensor 4, to measure the extension force, that is applied thereto, and to wirelessly transmit a signal 6 representative of the applied force to a remote receiver 7. The receiver may take any number of forms, such as a laptop or desktop computer, a mobile device such as a tablet or smartphone, or a dedicated hardware device; as such the type of receiver should not be seen as being limiting.

In use, the first elastic band 2 and second elastic band 3 surround the load sensor 4 and electronic circuit 5. Surrounding the load sensor 4 and electronic circuit 5, serves to protect them from damage such as shock from the load sensing device being dropped, knocked or stepped on.

The load sensing device 1 also includes a first removable fastener 8 in the form of a male clip fastener at a first end 10 and a second removable fastener 9 in the form of a female clip fastener at an opposite end 11. The first removable fastener 8 includes a recess into which an end of the first elastic band 2 and an end of the second elastic band 3 insert. Fasteners 12 attach the first elastic band 2 and the second elastic band 3 to the first removable fastener 8. Similarly the second removable fastener 9 includes a recess into which a further end of the first elastic band 2 and a further end of the second elastic band 3 insert. Fasteners 13 attach the first elastic band 2 and the second elastic band 3 to the second removable fastener 9.

With reference to FIG. 2, there is shown an exercise band 20, in use, with a first load sensing device 21 and a second load sensing device 22.

In FIG. 2 a user 23 is exercising with a human interface device in the form of bar 24. The bar 24 is attached to the first load sensing device 21 and second load sensing device 22 by way of a loop straps 25a and 25b. The loop of exercise band is held at a lowest position beneath the feet of the user. When the user pulls up on the bar, each of the first load sensing device 21 and second load sensing device 22, measure the extension force that is being applied to the exercise band 20.

It will be appreciated, that a single load sensing device may be used, in some embodiments, as the extension forces on each side of the exercise band will be roughly equivalent.

In FIG. 2 the first load sensing device 21 and second load sensing device 22 wirelessly transmit a signal representative of the extension force to receiver 26 in the form of a smart phone. The receiver 26 processes the signal and compares the measured tensile force to a pre-determined level of extension force programmed into the receiver by a therapist, personal trainer or the user. When the pre-determined level of extension force has been reached the receiver provides a feedback signal in the form of a vibration that indicates to the user that the current repetition of the exercise routine is complete.

In alternate embodiments the receiver may be a smart device or PC that provides a visual indication of the extension force measured on each of the first load sensing device 21 and the second load sensing device 22. In such embodiments the user can be notified of any imbalance in the action they are performing, such as right or left side dominance or a muscle imbalance. Alternatively the user may engage in a game, wherein the signals form the first load sensing device 21 and the second load sensing device 22 are used to control an action in the game, such as steering left or right by applying more or less force to one side or other of the bar, or jumping or moving forward by providing even upward pressure to the bar.

FIG. 3 shows one possible visual indication of the extension force measured by the first load sensing device 21 and second load sensing device 22 of FIG. 2, as generally indicated by designator 30. In FIG. 3 the extension force measured by each of the first load sensing device 21 and second load sensing device 22 is averaged to provide a single visual indication 31 of the extension force being applied. Each repetition of the exercise regime is indicated by peaks 32. As the user tires the peak extension force achieved decreases. The chart may be used to review endurance and peak output as well as to be compared with prior training history.

FIG. 4 shows a further visual indication of the extension force measured by the first load sensing device 21 and second load sensing device 22 of FIG. 2, as generally indicated by designator 33. In FIG. 4 the extension force measured by the first load sensing device 21 is shown in bar graph 34 and the extension force measured by the second load sensing device 22 is shown in bar graph 35. The dual bar graph display is useful to identify muscle imbalance or weakness.

A further visual indication, not shown, is an arcade game view where an exercise can be combined with an interactive game. For example a user may control an avatar such as a race car, runner, swimmer, or the like. The user pushes evenly up on the bar to a first pre-defined threshold in order to move forward, releases tension applied to the bar to a further predefined threshold to slow down, creates a right-left imbalance on the bar to steer left and a left-right imbalance on the bar to steer right, jumping or the like may be performed by a sharp evenly applied upwards force on the bar. Pre-defined thresholds may be provided for various actions as may be required for the game.

1. A load sensing device for use with an exercise band, the load sensing device including:
a band of resilient material;
a load sensor attached to the band and configured to measure an extension force applied to the band; and
an electronic circuit configured to measure the applied extension force and to wirelessly transmit a signal representative of the applied extension force to a receiver;
wherein the band of resilient material protects, the load sensor and the electronic circuit, from damage, by at least partially surrounding them.

2. The load sensing device as claimed in claim 1, including a further band of resilient material, wherein the load sensor is positioned so as to be sandwiched between the band of resilient material and the further band of resilient material.

3. The load sensing device as claimed in claim 1, wherein the resilient material is selected from the group consisting of one or more of:
rubber,
elastic; or
elastomer.

4. The load sensing device as claimed in claim 1, wherein the load sensor is configured to measure a distortion in the band of resilient material.

5. The load sensing device as claimed in claim 4 wherein the distortion is a thinning, or stretch, of the band of resilient material.

6. The load sensing apparatus as claimed in claim 4, wherein an electrical characteristic of the load sensing device varies as the band of resilient material is stretched.

7. The load sensing apparatus as claimed in claim 1, wherein a first removable fastener is included at a first end thereof, wherein the first removable fastener is configured, to removably attach, to a complementary fastener, attached to an exercise band.

8. The load sensing apparatus as claimed in claim 7 wherein a second removable fastener, is included at an opposite end, to the first end, wherein the second removable fastener is configured, to removably attach to a complementary fastener, attached to an exercise band accessory.

9. The load sensing apparatus as claimed in claim 1, wherein the receiver includes a microprocessor, configured to receive and decode the transmitted signal, representative of the applied extension force.

10. The load sensing apparatus as claimed in claim 9 wherein the microprocessor provides a feedback signal to a user of the load sensing device.

11. The load sensing apparatus as claimed in claim 10 wherein the microprocessor provides a feedback signal to a user of the load sensing device, when a pre-determined level of extension force, has been applied to the load sensing apparatus.

12. The load sensing apparatus as claimed in claim 11 wherein the pre-determined level of extension force is configurable.

13. The load sensing apparatus as claimed in claim 10, wherein the feedback signal is one or more of:
an audible alert;
a visual indication; or
a tactile signal.

14. The load sensing apparatus as claimed in claim 13 wherein the feedback signal is provided by way of an interaction with an avatar on a computer screen.

15. The load sensing apparatus as claimed in claim 9, wherein the processor records a user's exercise routine to a non-volatile memory.

16. A method for measuring the extension force applied to an exercise band, the method including the steps of:
a) measuring an extension force applied to the exercise band by way of a load sensing device;
b) transmitting a signal representative of the measured extension force wirelessly from the load sensing device to a receiver;
c) processing the signal representative of the measured extension force at the receiver; and
d) providing a feedback signal to the user indicative of their performance.

17. The method as claimed in claim 16 including the further step of:
e) a user setting a pre-defined threshold of extension force at which a feedback signal is to be provided to a user.

18. An exercise kit, including:
an exercise band including a clip fastener at one end; and
a load sensing device including a clip fastener configured to connect to the exercise band clip fastener;
wherein the load sensing device, is configured to measure an extension force applied to the exercise band, and to wirelessly transmit a signal representative of the extension force, to a receiver.

19. (canceled)

20. (canceled)
